(19) United States
(12) Patent Application Publication
(10) Pub. No.: US 2011/0076104 A1
(43) Pub. Date: Mar. 31, 2011

(54) PIPELINE POD TRANSPORT METHOD

(75) Inventor: Daniel Allen Ersoy, Lincolnwood, IL (US)

(73) Assignee: GAS TECHNOLOGY INSTITUTE, Des Plaines, IL (US)

(21) Appl. No.: 12/862,812

(22) Filed: Aug. 25, 2010

Related U.S. Application Data
(60) Provisional application No. 61/246,639, filed on Sep. 29, 2009.

(51) Int. Cl. B65G 51/36; B65G 51/00

(52) U.S. Cl. 406/34; 406/184

(57) ABSTRACT

A method for transporting gaseous, liquid, and solid materials in which a sealed containment vessel containing a material for transport is introduced into an underground pipeline or conduit. The sealed containment vessel is then motivated through the underground pipeline or conduit to a predetermined location. Pipelines for use in accordance with the method of this invention may be natural gas or water pipelines.

### CROSS-REFERENCE TO RELATED APPLICATION

This application claims the benefit of an earlier filed provisional application having Ser. No. 61/246,639 and a Filing Date of 29 Sep. 2009.

### BACKGROUND OF THE INVENTION

1. Field of the Invention

This invention relates to a method and system for transporting materials from one location to another. In one aspect, this invention relates to a method and system for transporting hazardous materials. In one aspect, this invention relates to a method and system for transporting gaseous, liquid, and/or solid materials. In one aspect, this invention relates to the use of underground pipelines or conduits as passageways for transport of materials. In one aspect, this invention relates to containment vessels for containment of materials transported through the underground pipelines or conduits. In one aspect, this invention relates to a method and system for controlling motivation of the containment vessels within the underground pipelines or conduits.

2. Description of Related Art

Generally speaking, a hazardous material is any item or agent, whether biological, chemical or physical, which has the potential to cause harm to humans, animals, or the environment, either by itself or through interaction with other factors and, as might be expected, the transporting of these materials from one location to another presents serious challenges which must be addressed to avoid serious damages or injuries. However, the need to transport some of these materials, such as hydrogen, is substantial and will grow in the future. Hydrogen is currently transported in cylinder trucks, by rail, or by ship, all of which produce greenhouse gases and congest traffic lanes. Ethanol, another hazardous material, is transported mainly by barge and rail and sometimes by truck with the same issues. These methods of transport are not nearly as safe, efficient, or environmentally friendly as pipeline transport. CO₂ is transported by a limited number of specialized, dedicated high-pressure pipelines which require very stringent integrity assessment practices under the Code of Federal Regulations.

As noted by the U.S. National Transportation and Safety Board, compared with barge, rail, and truck transport, pipelines are the safest mode of gas transport. However, most steel pipelines cannot transport hydrogen at high pressures for a variety of reasons. First, the pipelines can only be pressurized to a certain percentage of their specified yield strength. This means that for a typical pipeline, pressures will be in the range of hundreds to just over 1000 psig. Second, hydrogen can diffuse through steels and possibly lead to hydrogen damage, hydrogen embrittlement, and hydrogen induced cracking under certain conditions. However, by transporting hydrogen via pipeline, the necessity to burn fossil fuels, e.g. diesel fuel, in combustion engines such as used by trucks, barges, and rail transport, to move the commodity can be avoided. This would lower the emissions of greenhouse gases as well as the associated carbon footprint of the commodity.

Pneumatic tube systems are widely used in commercial applications to move articles from one location to another. Pneumatic tube systems generally utilize a hollow cylinder or “carrier” in which the materials are placed for transport within the system. The carrier containing the materials to be transported travel through pneumatic travel tubes. Such systems have been used in department stores and banks for bi-directional movement of currency, deposit slips, sales slips, and the like between the ends of a single tube.

### SUMMARY OF THE INVENTION

It is one object of this invention to provide a method and system for transport of gaseous, liquid, and solid commodities which address issues, such as greenhouse gas production and traffic lane congestion, associated with conventional commodity transport methods and systems.

It is one object of this invention to provide a method and system for transport of hazardous materials in which the risks associated with conventional transport methods and systems are reduced.

These and other objects of this invention are addressed by a method and system in which transport of gaseous, liquid, and solid commodities is carried out utilizing underground utility pipelines or conduits, e.g. natural gas and water pipelines, as passageways for directing suitable containment vessels containing the gaseous, liquid, and solid commodities from a first location to a second location. The method and system of this invention include remote means for tracking and controlling the travel of the containment vessels through the pipelines or conduits based upon the contents of the containment vessels.

### BRIEF DESCRIPTION OF THE DRAWINGS

These and other objects of this invention will be better understood from the following detailed description taken in conjunction with the drawings, wherein:

FIG. 1 is a schematic diagram of the basic concept of this invention showing commodity containment vessels disposed within a pipeline; and

FIG. 2 is a schematic diagram of a system in accordance with one embodiment of this invention for transport of commodities through a pipeline.

### DETAILED DESCRIPTION OF THE PRESENTLY PREFERRED EMBODIMENTS

The invention disclosed and claimed herein is a method for transporting hydrogen gas (or other gases), ethanol (or any other fluid), or solid material at ambient to high pressure by transport of pressurized containment vessels, e.g. cylinders or pods, through an underground pipeline or conduit. In order to ensure safe transport of the gas, liquid, or solid material through the pipeline, the containment vessel must be designed and constructed so as to be suitable for containing the particular gas, liquid, or solid material. In this respect, the containment vessels may be made of a specialized material (metallic, composite, etc.) or a combination of materials and layers to properly transport a given material. For example, for transporting hydrogen gas, the containment vessel or pod must have the proper rating and diffusion barriers to contain the hydrogen gas, which may be charged during the process of filling the containment vessel with hydrogen gas to a high pressure, e.g. 4000 psig. It will be appreciated that other containment vessels with less restrictive requirements may be used depending upon the material being transported therein. The containment vessels are motivated down a pipeline, similar to the mechanical devices, “pigs”, employed in in-line inspection in the gas and liquid pipeline industries. In addition to commodity transport, the containment vessels may also be used to clean and measure pipelines as conventional pigs do.

Motivation of the containment vessels through the pipeline in accordance with one preferred embodiment of the method of this invention is achieved using the surrounding flow of gas or liquid in the pipeline. For example, the driving force to move the containment vessels may be from fluid flow (drag) or differential pressure between the front and back of the containment vessels. In accordance with one embodiment of this invention, the driving force used to move the containment vessels involves electromagnetic driving of the containment vessels relative to the pipeline. It will be appreciated that other forms of locomotion of the containment vessels, e.g. mechanical or motorized, may be employed for moving the containment vessels in the pipelines, and such other forms of locomotion are deemed to be within the scope of this invention.

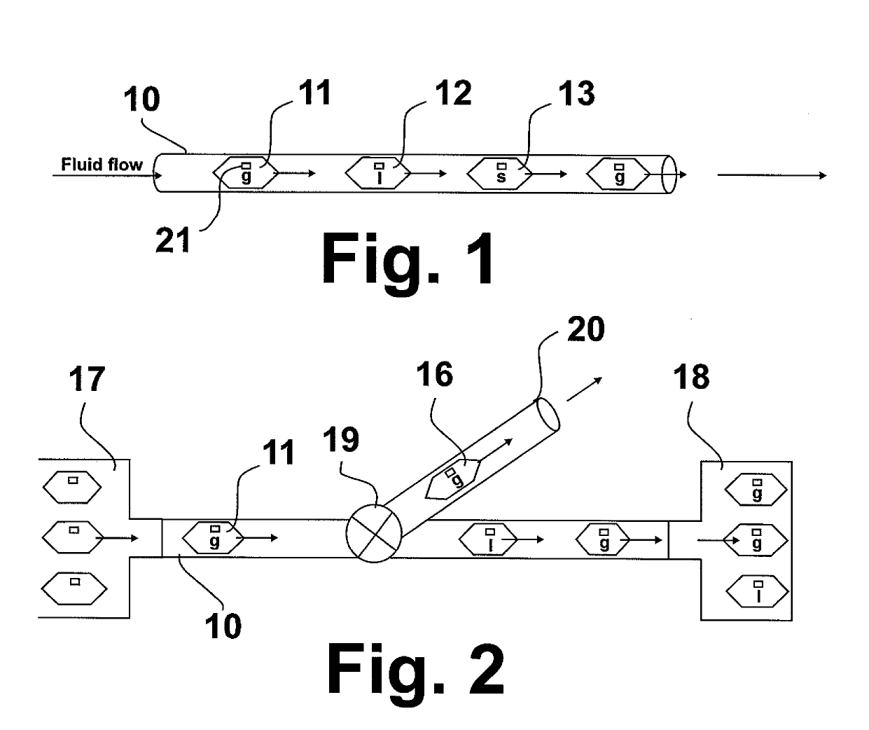

FIG. 1 is a diagram illustrating the fundamental concept of the method of this invention. As shown therein, containment vessels 11, 12, 13, containing a gaseous (g), liquid (l) and solid (s) material are disposed within a pipeline 10 through which a fluid, e.g. natural gas or water depending upon the normal fluid conveyance of the pipeline, flowing through the pipeline motivates each of the containment vessels in the direction of the fluid flow as indicated by the arrows.

FIG. 2 shows a typical system for the transport of materials through a pipeline in accordance with the method of this invention. As shown therein, containment vessels for transporting the materials are introduced into the pipeline 10 at a vessel injection or launch port 17. Due to the flexibility of the system, containment vessels containing different materials may be transported through the pipeline at the same time. The system further comprises a switching or transfer point 19 whereby a containment vessel 16 may be diverted from a main pipeline 10 to a branch pipeline 20. The containment vessels are motivated through the pipeline until they reach a collection/recovery station 18, at which point they may be sorted based upon their material contents and removed from the transport system.

By way of example, there may be a hydrogen production plant from a large wind farm on the west coast of the United States that feeds an electrolysis hydrogen production center. The hydrogen is compressed into suitable containment vessels or pods, which are then inserted into a pipeline containing a fluid transport medium within the pipeline which also surrounds the containment vessels. This fluid may be a liquid, such as water or a liquid hydrocarbon fuel, or a gas, such as natural gas or an inert gas such as nitrogen. The containment vessels are motivated through the pipeline until they reach the midwest part of the United States where the hydrogen is extracted from the containment vessels. The empty containment vessels may then be filled with compressed CO₂ or ethanol or another gas or liquid commodity and sent back down the same (flow reversal) or another pipeline to another location that needs the ethanol or will sequester the CO₂ gas. Likewise, the containment vessels themselves may be transported back to the hydrogen production site in another pipeline that is filled with CO₂ being moved to a sequestration site.

The system for transport of materials through a pipeline in accordance with the method of this invention comprises means for introducing the materials, i.e. gas, liquid, or solid, into the containment vessels and, after transport, for removing the materials from the containment vessels. As previously indicated, a plurality of containment vessels may be sent and run through a pipeline at the same time. There may also be many points along the pipeline route where the containment vessels may be diverted to a delivery point or even to a transfer point so they may be ported to another pipeline.

It will be appreciated by those skilled in the art that, with a system having the flexibility of the system of this invention, the ability to track the containment vessels as they travel through the pipeline is critical. This may be addressed in accordance with one embodiment of this invention by equipping the containment vessels with smart tags 21 (i.e. electronic ID devices), as shown in FIG. 1, readable from in the ground or above ground, which may indicate the containment vessel content, the source of the content, and the customer to whom the containment vessel is being sent as well as any other desired identification information. In accordance with one embodiment of this invention, the smart tags may be Radio-Frequency Identification (RFID) based which may be read by a RFID reader at appropriate locations along the pipeline to provide tracking of the containment vessels, routing of the containment vessels, time estimates of delivery, and the like. The tags may merely allow passive identification of the containment vessels or they may actually be used to control the transfer and switching points 19 of the system to direct the containment vessels to their specific destinations.

In the case of hydrogen transport in accordance with the method of this invention, by allowing the hydrogen to be pressurized to much greater pressures (e.g. 4000 psig) than the pipeline pressure (e.g. 700 psig) and placing the hydrogen in special containment vessels designed and rated for hydrogen transport, the gas may be easily moved down the pipeline while maintaining the pipeline pressurized at the much lower pressure (below the threshold for “transmission rating”).

By using containment vessel transport in accordance with the method of this invention, the hydrogen or other commodities may be transported in existing pipelines. New pipelines are not required to be built or specially designed for high pressure hydrogen, CO₂, or other commodity transport. The primary requirement is a suitable containment vessel for use with the intended commodity. New pipelines may also be built for transport; but, advantageously, such new pipelines would not have to meet the same stringent and extremely expensive criteria applied to high pressure pipelines.

It will be appreciated that as the age of the current pipeline infrastructure increases, many high pressure pipelines may have to be down rated in pressure as their integrity or pressure containing capacity drops due to corrosion or other factors. The method of containment vessel transport in accordance with this invention means that one may significantly drop the pressure of the pipeline (carrier fluid) while maintaining the pressure of the containment vessel as high as desired.

For the transport of explosives or toxic gases and liquids through a conventional pipeline system, there is always a concern as to the consequences of pipeline leaks or ruptures. A rupture or leak of a high pressure hydrogen or ethanol pipeline could be catastrophic. On the other hand, even if a containment vessel employed in accordance with the method of this invention were to leak or rupture, the surrounding carrier pipeline would provide a very large secondary containment space into which the hydrogen or ethanol may expand. The surrounding space may be filled with an inert gas or nitrogen which would further provide protection from ignition of the commodity being transported.

Current pipelines cannot easily, if at all, switch between products or send two or more products in parallel as is possible with the method of this invention. For example, in accordance with one embodiment of this invention, one or more products could be introduced into separate containment vessels and a gaseous or liquid commodity surrounding the pods in the pipeline could also act as the propulsion media. One may send multiple fuels, gases, liquids, pipeline, even at the same time, by using multiple pods and then automatically sorting them after delivery or transfer location.

As for safety concerns, even if a single containment vessel does not pass periodic safety inspections or checks, it can easily be replaced without disruption to the main pipeline and the other containment vessels. By comparison, a conventional pipeline typically would have to be shut down and, at a minimum, would have to have the operating pressure reduced while repairs are being made.

While in the foregoing specification this invention has been described in relation to certain preferred embodiments thereof, and many details have been set forth for the purpose of illustration, it will be apparent to those skilled in the art that the invention is susceptible to additional embodiments and that certain of the details described herein can be varied considerably without departing from the basic principles of the invention.

What is claimed is:

1. A method for transporting materials comprising the steps of:
introducing a material for transport into a containment vessel suitable for maintaining said material inside said containment vessel and sized to fit inside an underground conduit;
introducing said containment vessel into a fluid flowing through said underground conduit; and
motivating said containment vessel through said underground conduit.

2. The method of claim 1, wherein said fluid is a gas.

3. The method of claim 1, wherein said fluid is a liquid.

4. The method of claim 1, wherein said material is selected from the group consisting of solids, liquids, gases, and combinations thereof.

5. The method of claim 1, wherein said containment vessel comprises identification means for identifying said containment vessel from an aboveground location.

6. The method of claim 1, wherein said containment vessel comprises direction control means for controlling a direction of motivation of said containment vessel through said conduit.

7. The method of claim 5, wherein said identification means comprises a smart tag.

8. The method of claim 6, wherein said direction control means comprises a smart tag.

9. The method of claim 1, wherein said containment vessel is motivated through said underground conduit by a driving force selected from the group consisting of fluid flow (drag), differential pressure across said containment vessel, electromagnetic, and combinations thereof.

10. The method of claim 1, wherein a plurality of said containment vessels are simultaneously motivated through said underground conduit.

11. The method of claim 10, wherein said containment vessels contain different said materials.

12. The method of claim 1, wherein said material is a hazardous material.

13. The method of claim 1, wherein said material is a pressurized gas.

14. The method of claim 13, wherein said pressurized gas is hydrogen.

15. The method of claim 11 further comprising automatic sorting of said containment vessels in said underground conduit at a predetermined location.

16. The method of claim 1, wherein said containment vessel provides at least one of cleaning and measuring of said underground conduit as it is motivated through said conduit.

17. A method for transporting materials through an underground conduit comprising the steps of:
introducing a sealed containment vessel containing a material for transport into said underground conduit; and
motivating said sealed containment vessel through said underground conduit to a predetermined location.

18. The method of claim 17, wherein said containment vessel is suitable for containing hazardous materials.

19. The method of claim 17, wherein said containment vessel is suitable for containing fluids at pressures greater than atmospheric.

20. The method of claim 17, wherein said sealed containment vessel is motivated through said underground conduit by a fluid flowing through said underground conduit.

21. The method of claim 20, wherein said fluid is natural gas.

22. The method of claim 20, wherein said fluid is water.

23. The method of claim 17, wherein said containment vessel is motivated through said underground conduit by electromagnetic drive means.

24. The method of claim 17, wherein said containment vessel comprises identification means for identifying said containment vessel from an aboveground location.

25. The method of claim 24, wherein said identification means comprises a smart tag.

26. The method of claim 25, wherein said smart tag is used to control said motivating of said containment vessel through said underground pipeline.
